(19) United States
(12) Patent Application Publication
(10) Pub. No.: US 2002/0132609 A1
(43) Pub. Date: Sep. 19, 2002

(54) Scalable and secure messaging system for a wireless network

(76) Inventors: Allan D. Lewis, New Dundee (CA); Tabitha K. Ferguson, Waterloo (CA); James A. Godfrey, Waterloo (CA); Carl L. Cherry, Kitchener (CA); Bill Yuan, Waterloo (CA)

Correspondence Address: Joseph M. Sauer, Esq., Jones, Day, Reavis & Pogue, North Point, 901 Lakeside Ave, Cleveland, OH, 44114, US

(21) Appl. No.: 10/098,083

(22) Filed: Mar. 14, 2002

Related U.S. Application Data
(60) Provisional application No. 60/275,958, filed on Mar. 14, 2001.

(51) Int. Cl. H04M 11/10

(52) U.S. Cl. 455/412; 455/413

(57) ABSTRACT

A scalable messaging system for wireless networks is disclosed. Multiple email servers connect to a mailbox server through respective client interfaces. The client interfaces are implemented so that if an email server ceases to communicate with a client, the mailbox server continues to function. Multiple mailbox servers are connected to a single wireless router. The router is preferably located between an internal firewall and an external firewall. The wireless router acts as a server for the mailbox servers and multiplexes messages received from the mailbox servers into a single stream. The single stream is transmitted through a single port in the external firewall, thus providing only one connection through the external firewall.

### CROSS-REFERENCE TO RELATED APPLICATION

This application claims priority from U.S. Provisional Application Ser. No. 60/275,958, filed on Mar. 14, 2001. The complete disclosure of this provisional application, including drawings, is hereby incorporated into this application by reference.

### FIELD OF THE INVENTION

This invention relates to the art of wireless networks. In particular, this invention relates to adapting traditional messaging systems to operate in a fault tolerant, secure, scalable and centrally administered fashion with a wireless network.

### BACKGROUND OF THE INVENTION

In traditional messaging, such as messaging based on Microsoft's ® Messaging API (“MAPI”), a messaging session is conducted between a messaging client and a messaging server over several possible communication paths, which usually involve a network connection between the messaging client and the computer on which the messaging server resides. The use of a Local Area Network (LAN) to provide the network connection between client and server is well known.

A common problem with traditional messaging occurs when communication with the server is interrupted, i.e. the LAN is congested or the network connection is broken for some reason. These types of breaks are common, either through software problems or due to physical wiring or congestion problems. Often these types of session hangs can result in a blocked or unusable client, and the client or the server component have to be stopped and restarted.

Even though this problem affects any system that uses traditional messaging clients to access messaging servers, the congestion and blocking problem has an even more dramatic affect when creating a client proxy for a group of clients, as is the case in a wireless network. Wireless server systems are even more affected because they often are used to multiplex an entire company's wireless user community through a single communication link to a wireless network. A messaging delay or blockage in a wireless server system can block communications for all users of the wireless server, not just the individual user that might be the source of the problem.

A second problem is encountered in large deployments, such as when several messaging servers exist in various locations, often as a result of the progressive growth of an organization. In large deployments, the use of a single wireless server for coupling the messaging servers to the wireless network does not scale well. As new messaging servers are added throughout the organization, their number can quickly exceed the capacity of a single wireless server. One solution is to add another wireless server system, and create another link to the wireless network, but this causes security problems. Each link to the wireless network can present a security risk with respect to the messaging servers, as communications between the wireless network and the wireless server have to go through the company's firewall, thereby creating a security “hole”. Adding more links between these two systems compounds the security risk as it also introduces more “holes” in the firewall.

Therefore, there is a need for a system and method that implement a new architecture for adapting traditional messaging to wireless networks, the new architecture being fault tolerant, scalable, and secure.

### SUMMARY OF THE INVENTION

A messaging system for a wireless communication network is provided. The system may include a plurality of mailboxes, one or more email servers, each email server connected to a unique subset of the plurality of mailboxes, one or more mailbox servers, each mailbox server connected to a unique subset of the email servers, and a wireless router connected to each of the mailbox servers, the wireless router communicating with the wireless network to transmit messages from the plurality of mailboxes to the wireless network and to transmit messages received from the wireless network to the plurality of mailboxes.

A method for transmitting data in a wireless communication system is also provided, and may include the steps of monitoring to detect a change to one or more data stores, determining if the change requires that a message be sent to a wireless device in the wireless communication system, and if so, creating the message, and if not, returning to the step of monitoring, saving the message in a message store, determining which wireless device should receive the message, and sending the message to the wireless communication system for delivery to the wireless device.

A system for transmitting data in a wireless communication system is provided, and may comprise means for monitoring to detect a change to one or more data stores, means for determining if the change requires that a message be sent to a wireless device in the wireless communication system, and if so, creating the message, means for saving the message in a message store, means for determining which wireless device should receive the message, and means for sending the message to the wireless communication network for delivery to the wireless device.

A method of receiving data in a wireless communication network is provided. The method may include the steps of determining if the data is a message for a user of the wireless network, and if so, storing the message in a message store, consulting a lookup table to identify a server controlling data for the user, sending the data to the server via a router client, and deleting the message from the message store upon receipt of an acknowledgement from the server, and determining if the data is an acknowledgement of a message received by a wireless device in the wireless communication network, and if so, deleting the message associated with the acknowledgement from a message store, decrementing the number of outstanding messages sent to the wireless device, consulting a lookup table to identify a server controlling data for wireless device that sent the acknowledgement, and informing the server of the acknowledgement.

A method of managing a data store in a wireless communication network is also provided, and may comprise the steps of receiving a message from a router, determining if the message comprises data to be stored for a user of the wireless network, and if so, acknowledging the receipt of the message to the router, identifying a data store for the user, storing the data from the message in the data store, and determining if the message is an acknowledgement of a message received by a user of the wireless network, and if so, decrementing the total number of outstanding message for the user.

### BRIEF DESCRIPTION OF THE DRAWINGS

For a better understanding of the present invention, and to show more clearly how it can be carried into effect, reference will now be made, by way of example only, to the accompanying drawings in which:

FIG. 1 is a block diagram of a wireless communication system;

FIG. 2 is a block diagram of the email components of FIG. 1;

FIG. 3 is a block diagram of the wireless server components of FIG. 2;

FIG. 4 is a block diagram of a wireless communication system with multiple mailbox servers;

FIG. 5 is a block diagram of a wireless communication system with administration functionality;

FIG. 6 is a logical flow diagram of a wireless communication process;

FIG. 7 is a logical flow diagram of a process for the startup of the system of FIG. 5;

FIG. 8 is a logical flow diagram of a data store change process;

FIG. 9 is a logical flow diagram of the process of the wireless router receiving data from a mailbox server;

FIG. 10 is a logical flow diagram for messages coming in from the wireless network; and

FIG. 11 a logical flow diagram of the process of a mailbox server receiving data.

### DETAILED DESCRIPTION OF THE INVENTION

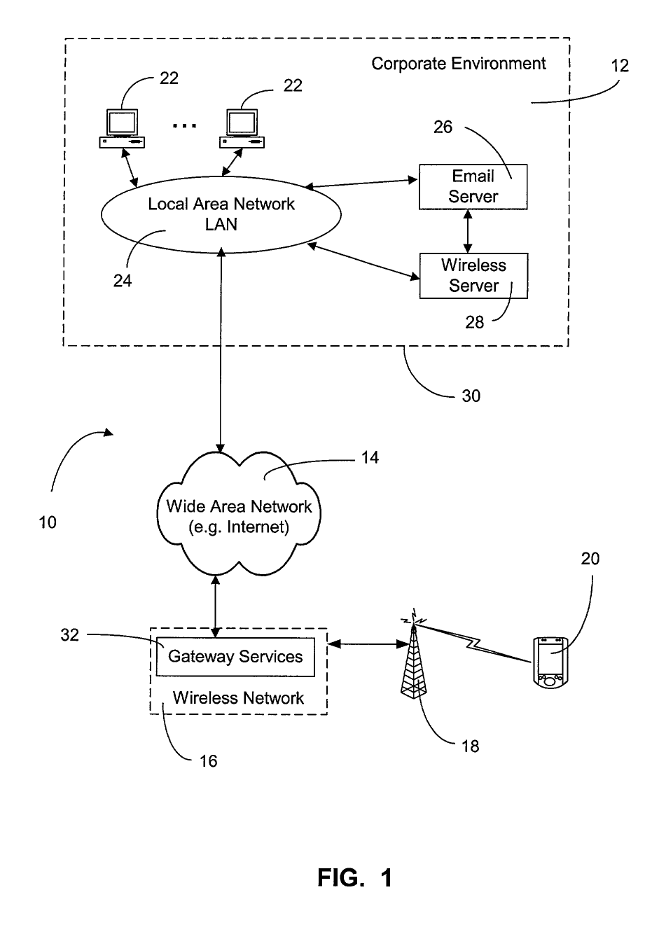

Referring first to FIG. 1, a block diagram of a wireless communication system is shown generally as 10. System 10 comprises a corporate environment 12, a Wide Area Network (WAN) 14, a wireless network 16, a wireless transmitter 18 and a wireless device 20. Corporate environment 12 comprises a plurality of desktop computers 22, a local area network (LAN) 24, email server 26 and wireless server 28, located behind a security firewall 30. The term “Corporate Environment” 12 may also be referred to as an “Enterprise Environment”, “Internet Service Provider Environment”, or “Network Carrier Environment”, and may for example be the computer resources of a business entity.

System 10 illustrates the connections between a user's desktop computer 22 and a user's wireless device 20. In such a system any messages received by user's desktop computer 22 are transmitted to user's wireless device 20. Thus, the message contents of wireless device 20 mirror those of computer 22. Similarly, any outgoing messages from device 20 are stored on the user's desktop computer 22. This “mirroring” of messages is accomplished by wireless server 28 which reformats each message to allow it to be accepted by WAN 14 or LAN 24. Server 28 may also compress or encrypt a message. Although system 10 utilizes desktop computers 22, it is not necessary that a desktop computer 22 be the source and receiver of a user's messages. Such functionality may also be provided by a server (not shown) which mirrors messages for a plurality of users. The desktop computers 22 may be replaced by a server, multiple servers, or coexist with one or more servers.

In use, a user may send a message from or receive a message at wireless device 20. A message may be an email, or alternatively any form of data, instructions or data combined with instructions. Examples of messages would include data from databases such as those provided by SAP® or a Customer Relationship Manager (CRM). Further, a message from a wireless device 20 may contain data and instructions to update such databases. Wireless device 20 may be viewed as simply another device connected to corporate environment 12. If the user of wireless device 20 has the appropriate authority, any task may be accomplished by sending a message.

A message received at wireless device 20 may originate from two sources. A message sender may be within the corporate environment 12 or external to corporate environment 12, for example user that sends an email over the Internet 14.

In the first case, the message is transmitted by a network internal to the corporate environment 12, such as LAN 24. Email server 26 receives the message and determines if the message is to a user who has a wireless device 20. If this is the case, the message is forwarded to wireless server 28 which determines the address of the appropriate wireless device 20 repackages the message and sends it to LAN 24 so that it appears as a regular outgoing email message. LAN 24 then forwards the message through firewall 30 to WAN 14. The message is then transmitted to wireless network 16 which forwards it to wireless transmitter 18 which then forwards it to the appropriate wireless device 20 for reception by the user.

In the second case, for a message generated external to corporate environment 12, WAN 14 routes the message through firewall 30 to LAN 24 and thus to a desktop computer 22. If there is a wireless device associated with desktop computer 22, then the message will be forwarded to wireless device 20 as described above.

A user of wireless device 20 may also send a message, either an original message or a response to a message received. In this case wireless device 20 sends the message to wireless transmitter 18. The message is then forwarded to wireless network 16. The message is next sent via WAN 14 to LAN 24 and received by desktop computer 22. It is then acted upon by the email server 26 as for any other message as described above.

Wireless network 16 may be any of a variety of networks, including for example: (1) the Code Division Multiple Access (CDMA) network, (2) the Groupe Special Mobile or the Global System for Mobile Communications (GSM) developed the standards committee of Conference Européenne des Administration des postes et des télécommunications (CEPT), (3) the General Packet Radio Service (GPRS) network developed by CEPT, (4) third generation networks such as Enhanced Data rates for Global Evolution (EDGE) and Universal Mobile Telecommunications Systems (UMTS), which are currently under development, (5) the Mobitex™ radio network, and (6) the DataTAC™ radio network.

Gateway services 32 serve to integrate the communication protocol of the WAN with the protocol of wireless network 16. Gateway services 32 may be provided by the operator of network 16 or by a third party. Services 32 allow corporate environment 12 to access a wireless device 20. Services 32 may include addressing services, packetization services and packet acknowledgement services.

Addressing services will be required if wireless network 16 operates within a private address space. For example, in the Mobitex network, each wireless device 20 is assigned a private Mobitex Access Number (MAN), which is used to access direct points in the Mobitex network. In a GPRS network, the Internet Protocol (IP) address for each wireless device 20 is private and dynamically assigned. As can be seen from these two examples, the scheme for addressing a wireless device 20 may vary broadly depending upon the network 16 that is used.

Packetization services are required when network 16 is using a proprietary protocol, because packets of data need to be formatted to meet the protocol. An example of this is the Mobitex network, which uses Mobitex Packets (MPAKs) to exchange data.

With regard to packet acknowledgement services, in some networks it is possible to provide distinct acknowledgements when packets are received.

As one skilled in the art can appreciate, any number of other computers, not just desktop computers 22, may be connected to LAN 24. Further, the network 24 may include any number of networks that connect systems capable of receiving and transmitting data. Similarly, WAN 28 may comprise any number of networks using a variety of protocols. The illustrative example of network 14 used herein is the Internet, which uses the Internet Protocol (IP).

Although email server 26 and wireless server 28 are shown as separate blocks, they may reside on a single computer connected to LAN 24. In such a configuration, communications between server 26 and server 28 will be more robust, as they will not rely on a network connecting them to each other.

The wireless device 20 is preferably a hand-held two-way wireless paging computer, a wirelessly enabled palm-top computer, a mobile telephone with data messaging capabilities, or a wirelessly enabled laptop computer, but could, alternatively be other types of mobile data communication devices capable of sending and receiving messages via wireless network 16.

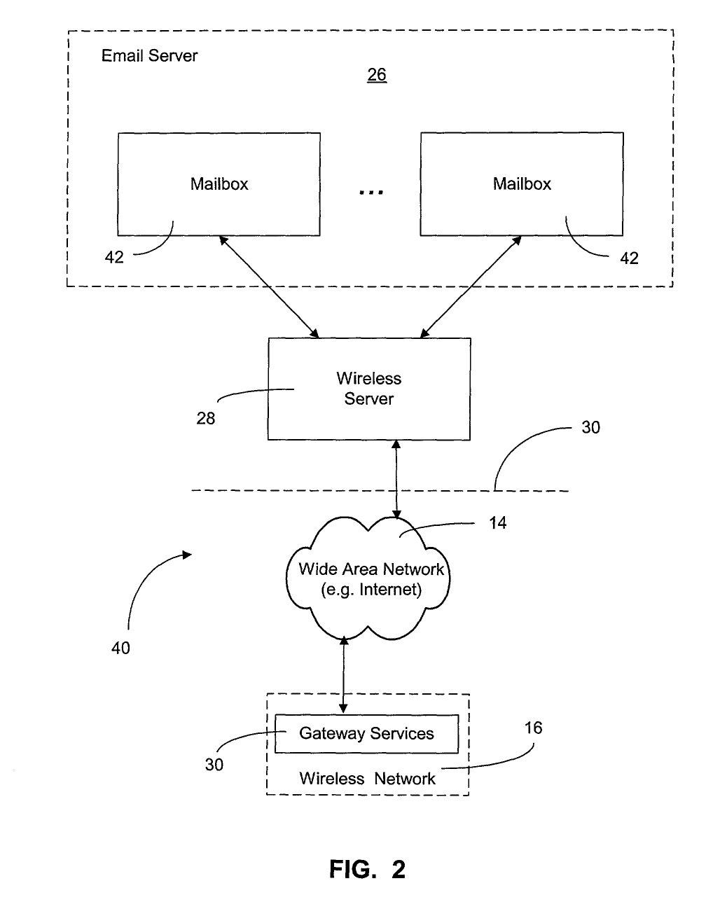

Referring now to FIG. 2, a block diagram of the email components of FIG. 1 is shown generally as 40. Email server 26 comprises a plurality of mailboxes 42. Mailboxes 42 are normally mapped one-to-one to users authorized to use email within corporate environment 12. The mailboxes 42 may reside on email server 26 or any other computers within corporate environment 12. Email server 26 monitors mailboxes 42 for activity and works with wireless server 28 to transmit and receive wireless messages via wireless network 16. As shown in FIG. 1 and described above, the email server 26 is also configured to receive and send email via the WAN 14 through its own direct or indirect connection (not shown in FIG. 2) to the WAN 14.

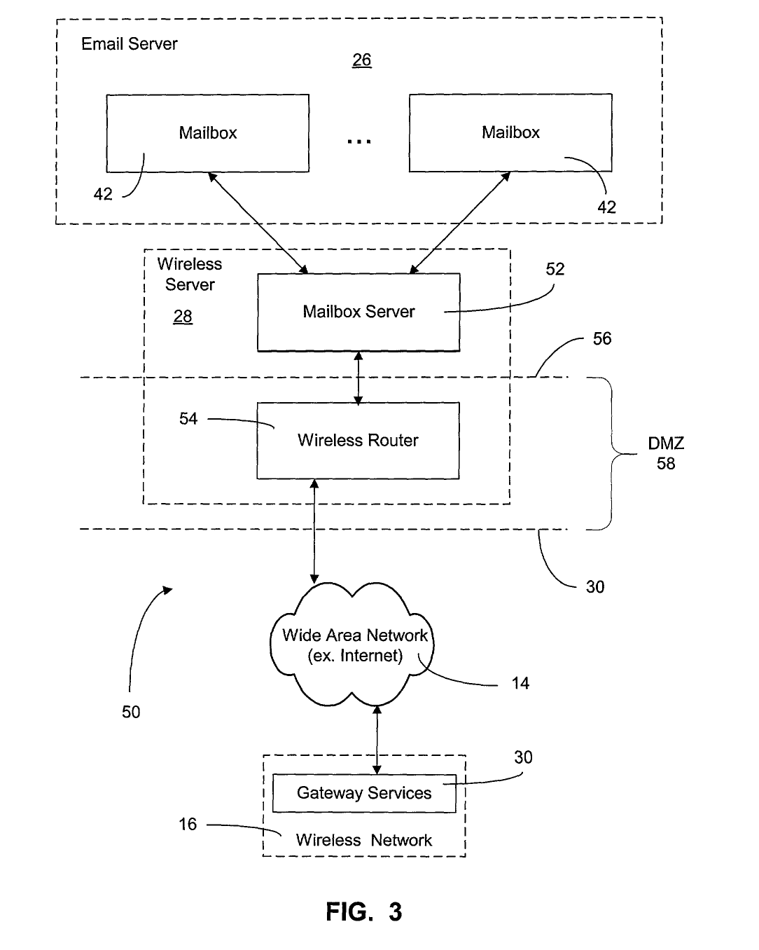

Referring now to FIG. 3, a block diagram of the wireless server components of FIG. 2 is shown generally as 50. Wireless server comprises mailbox server 52 and wireless router 54. Mailbox server 52 monitors email server 26 to receive outgoing messages from mailboxes 42 and transmits incoming messages to mailboxes 42. Mailbox server 52 is separated from wireless router 54 by an internal firewall 56. Thus, wireless router 54 resides in a “demilitarized zone” (DMZ) 58 between internal firewall 56 and external firewall 30. This structure provides two advantages in that it isolates the external communication component (wireless router 54) from corporate environment 12 and it provides a single contact through external firewall 30. This is particularly important for security reasons if WAN 14 is the Internet. The placement of wireless router 54 within DMZ 58 makes it very difficult for external hacking attempts to get past router 54 through internal firewall 56. Although the location of the wireless router 54 within a DMZ is desirable for security reasons it is not a requirement to practice the present invention. For example, the WAN 14 may be a corporate extranet which is well protected, so that the use of a DMZ may not be necessary.

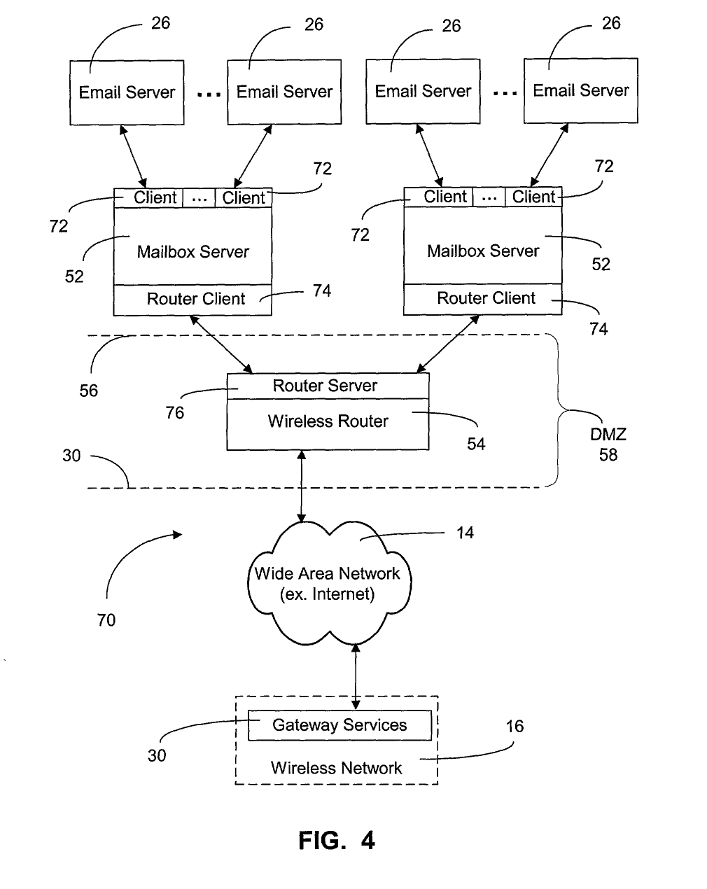

The division of labour between mailbox server 52 and wireless router 54 permits wireless router 54 to continue to transmit and receive messages should mailbox server 52 hang. This is particularly useful when multiple mailbox servers are utilized as shown in FIG. 4.

Referring now to FIG. 4, a block diagram of a wireless communication system with multiple mailbox servers is shown generally as 70. System 70 illustrates how system 50 may be expanded to include multiple mailbox servers while maintaining a single point of contact through external firewall 30.

As more and more email users are added in corporate environment 12, additional email servers 26 may be added. Similarly, additional mailbox servers 52 may be added. In such a configuration, a client/server model is preferably adopted. Each mailbox server 52 will have a mailbox client 72 for each email server 26 that it communicates with. A traditional problem with having a mailbox server communicate with a plurality of email servers, is that if communication with a single email server fails, all operations on a mailbox server stop. This problem may be addressed in one of two ways. The first solution as shown in FIG. 4, provides for multiple clients 72. Each client 72 runs as a separate thread or process on mailbox server 52. Thus if a client 72 is unable to communicate with an email server 26, only that client 72 is affected. In an alternative embodiment, a mailbox server 52 may serve a single email server 26. In such an embodiment both mailbox server 52 and email server 26 may reside on the same physical machine to provide for more robust communications between them as they will not need to rely on an external communication link.

As wireless router 54 has multiple mailbox servers 52 to communicate with, router 54 adopts the client/server model as well. Each mailbox server 52 will have a router client 74 that communicates with router server 76. Should the messaging load be too much for a single router server 76, additional servers 76 may be added, each of which having its own connection to WAN 14 through external firewall 30. To provide for a more robust implementation, two or more routers 54 may be installed on separate machines but operate together through a single connection through the firewall 30. Should one router cease to function, the others may take over. In one possible implementation, each router may frequently request status from the others. Should a router fail to respond, it may be dropped from the network of routers until it comes up again and announces its presence. Other options include, for example, load sharing until one router fails to respond to a task, in which case it is dropped from the network of routers. A router client 74 may also detect that a particular connection to a router server 76 is inoperative and request a connection to another router server 76.

The implementation of the architecture of system 70 ensures that any communications failure between an email server 26 and a mailbox server 52 does not impact the other servers 26 and 52. Router 54 will continue to function should a mailbox server 52 become inoperative. Further, by locating router 54 within DMZ 58, no new holes appear in external firewall 30 when a new mailbox server 52 is added.

Router 54 multiplexes information from multiple router clients 74 into a single wireless protocol session. Any number of protocols may be used, including but not limited to: proprietary, HTTP, XML, SSL, TCP/IP, MIME (or SMIME) over SMTP over TCP/IP, a proprietary protocol over UDP/IP, and others. By doing so, router 54 acts as a client for wireless network 16.

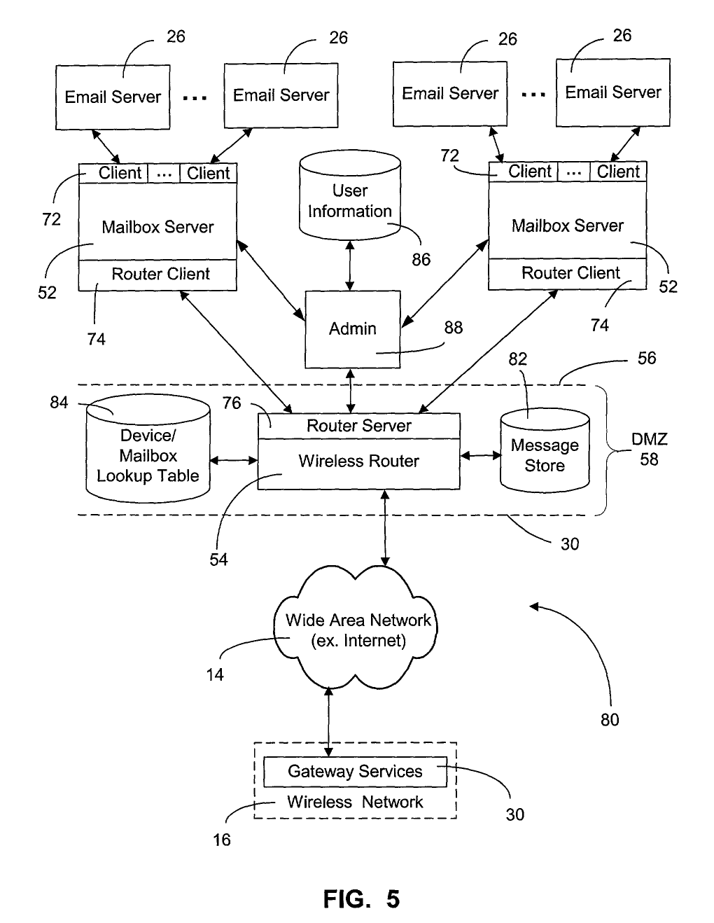

Referring now to FIG. 5, a block diagram of a wireless communication system with administration functionality is shown generally as 80. System 80 illustrates the structure of administration features that may be included in system 70.

System 80 stores administration and configuration information in a user information database 86. In order to administer all the mailbox servers and the router centrally, a server administration component 88 is preferably provided. Although not shown, a user administration interface may be connected to component 88. Such a user administration interface would allow a system administrator to work with system 80, for example by providing the ability to add new mailbox servers 52 and new email servers 26. Any communication to and from administration component 88 is preferably encrypted to ensure the security of configuration information and user information, including encryption keys.

Wireless router 54 maintains a list of in-process transactions and their current state in message store 82 thereby providing transaction persistence. Once a message is successfully sent to router 54 and saved to message store 82 it need not be resent by a mailbox server 52. Should the connection between a mailbox server 52 and wireless router 54 fail, the mailbox server 52 may query the router 54 to determine if a message is in message store 82. Mailbox server 54 may also resubmit messages periodically, such as every few hours to ensure that any corruption of message store 82 is corrected. Further, router 54 may send confirmation data to mailbox server 52 that a message has been stored or sent. A mailbox server 52 may also request that a message previously submitted to router 54 not be sent. This is of course dependant upon when such a request is received, as it may arrive at the router 54 after the message has already been sent. When router 54 completes the processing of a message, a result code is returned to the mailbox server indicating the final disposition of the message.

When router 54 receives a message from a user's wireless device 20, through wireless network 16, a device/mailbox lookup table 84 is accessed to determine which particular mailbox server 52 is handling the user's desktop system. Messages destined for wireless devices 20 do not require any lookup and are passed on to wireless network 16. Wireless device and mailbox server information may be extracted from outgoing messages and compared to user information database 86 to ensure that the user information database 86 and the device/agent lookup table 84 remain synchronized.

Because the wireless router 54 is separate from the mailbox servers 52, the failure of a mailbox server will not prevent router 54 from continuing to handle messages. In particular, any necessary message encoding functions, such as compression, encryption and packaging format may be resident in router 54, thus reducing dependency on a mailbox server 52.

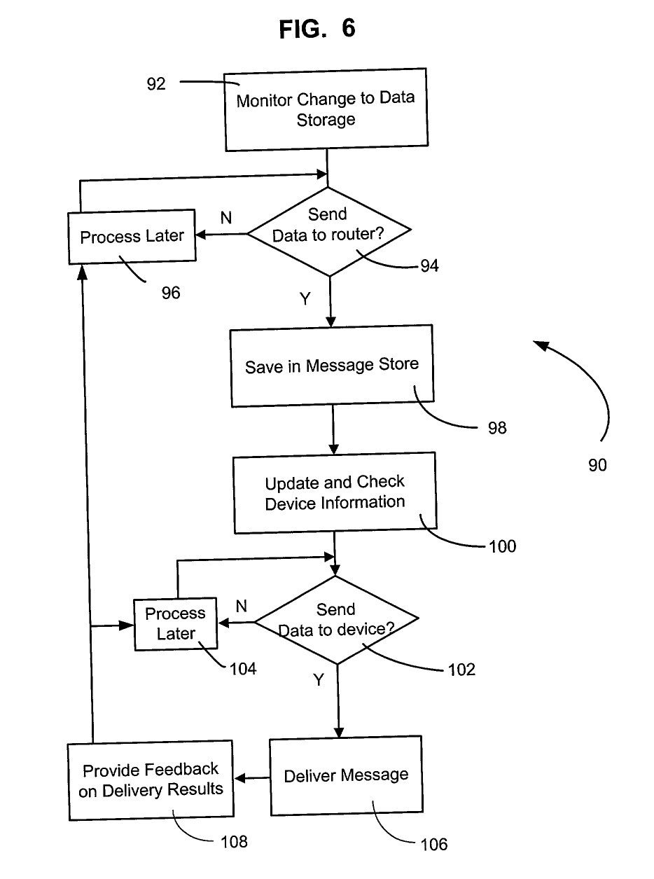

Referring now to FIG. 6, a logical flow diagram of a wireless communication process is shown generally as 90.

Process 90 begins at step 92 where a change to a data storage area is detected. Typically a data storage area would be a mailbox 42, but it may encompass other types of data storage such as updates to a CRM database. The detection of a change may take many different forms. For example, a client 72 may request that an email server 26 inform client 72 if mail has been received. Change or advise requests such as these are also provided by many database suppliers such as Oracle® and MAPI. In another example, through the use of Remote Program Calls (RPC), such as those utilized by Lotus Notes, a polling method may be used to ask if any updates to a data store have occurred. Ideally, each data storage area is monitored by a single thread. Thus, if the thread should fail, monitoring for all other data storage areas will continue. This is analogous to the client model described above for mailbox server 52 and as shown in FIG. 5. Further, should a single thread fail a new one may be created.

At step 94 a decision is made as to whether or not the change to the data storage detected at step 92 warrants sending a message to a wireless device 20. A number of variables may be considered in making such a decision, including the state information for the wireless device that is associated with or interested in changes to the data storage and the current outstanding messages already sent to that mobile device.

A wireless device 20 may have requested that certain types of information not be forwarded. For example, such certain types of information may include a FAX, voice mail or a binary attachment to an email message, messages from certain message senders, database changes to certain files, or web-page changes to certain web content. Wireless device state information may also be consulted before determining if a message is to be sent. Also, a wireless device 20 may not have acknowledged receipt of previous messages and a decision may be made not to send anymore until the previously sent messages have been received.

If a decision has been made not to send data to a wireless device, then process 90 moves to step 96. At step 96, process 90 continues to watch for future data store changes or for acknowledgements of data being received by wireless device 20.

If data is to be sent, then mailbox server 52 reads the pertinent parts of the changed data store, e.g. those parts of the email message that the wireless device has been programmed to accept. Mailbox server 52 then prepares a message for wireless router 54, and router client 74 sends the message to router server 74. Once the message has been received, an acknowledgement is returned to router client 74 and mailbox server 52 marks the data store item to indicate that it has been prepared and sent. Later, when the message is received at a specific wireless device 20 and acknowledged, the total number of outstanding messages for the specific wireless device 20 will be decremented so that other messages may be sent to the specific wireless device 20. In this manner messages to a specific wireless device 20 are paced so that wireless router 54 does not become overloaded with messages. This also helps to ensure that message store 82 does not fill up with unsent messages. For example, if a user is on vacation for an extended period of time and thus messages sent are not being acknowledged, there is no point in sending all of their messages to wireless router 54 when there is no record of the user having received them for days or weeks. However, mailbox server 52 will preferably provide several messages to wireless router 54 so that wireless router 54 can efficiently deliver data as mailbox server 52 is accessing and preparing the data to be sent. This method of keeping a few messages at each stage of the delivery path is called “pipelining” and helps to make the overall system run more efficiently.

At step 98, wireless router 54 has received the data and stores it in message store 82 (FIG. 5).

At step 100 the device/mailbox lookup table 84 is accessed to determine which user device 20 and mailbox server 52 are involved with the message exchange. As discussed earlier, messages may be other than emails, and the reference to mailbox server 52 serves only as an example. Additionally, the wireless router 54 can preferably track the number of outstanding number of messages or datagrams per device so that it can limit the total messages being held for mobile devices. A datagram is a self-contained, independent entity of data carrying sufficient information to allow it to be routed from the source to the destination computer without reliance on earlier exchanges between the source and destination computer and the transporting network. Therefore, a datagram may include an entire message or possibly only a portion of a long message.

At step 102 a decision is made as to whether or not the message should be sent. A number of variables may be considered in making such a decision, including:

a) the speed of the wireless network 16; and

b) available storage space in other parts of the system; which may include storage in wireless router 54, gateway services 30 and wireless network 16.

An example with regard to b) would comprise a router 54 capable of holding ten outstanding messages, gateway services 30 that may hold four outstanding messages and wireless network 16 that may allow two outstanding datagrams for a single wireless device 20. This overall knowledge of storage space allows wireless router 54, gateway services 30 and wireless network 16 to optimize the transmission of messages. As described earlier this is achieved by pipelining, i.e. passing information to another component via a “pipe” in a timely fashion to ensure that there is always something in the pipe to be processed while at the same time not overloading the pipe.

If a decision has been made not to send data then process 90 moves to step 104. At step 104, process 90 monitors system conditions and will attempt to resend the message when possible.

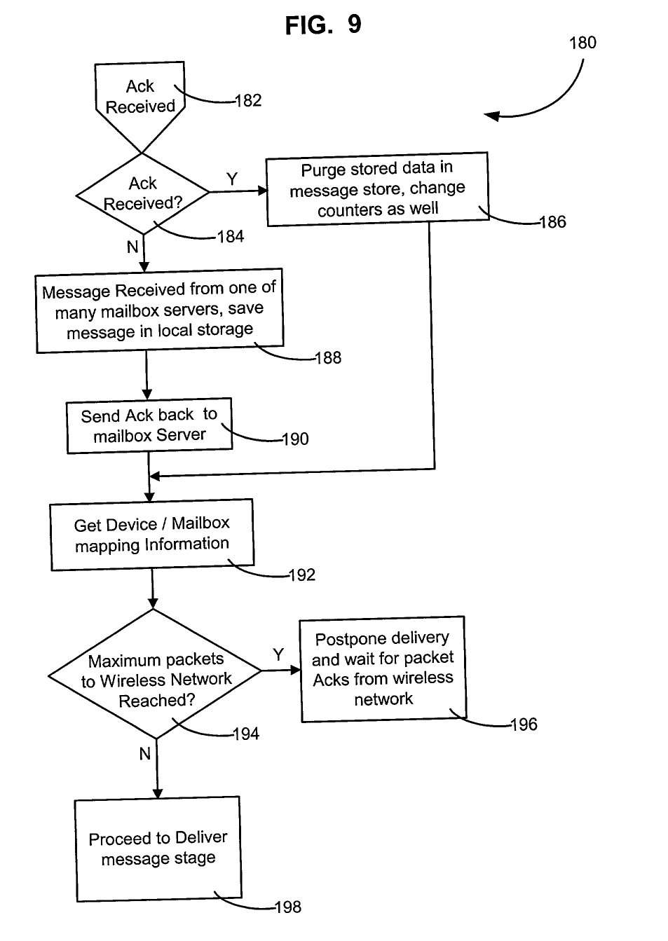

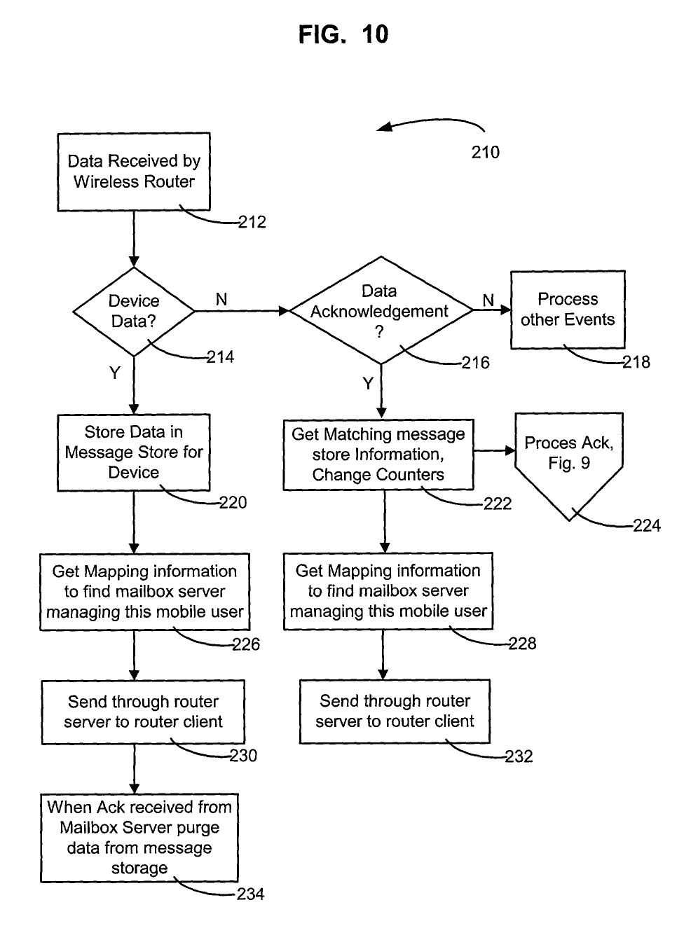

At step 106 the message is delivered by wireless router 54 via wireless network 16 to the intended user's wireless device 20. Once the message has been successfully delivered, an acknowledgement is preferably sent from the device and received at step 108. Step 108 provides the notification of an acknowledgement to steps 96 and 104 to update the variables considered by steps 94 and 102. Further, once a message has been acknowledged by a wireless device 20, it may be removed from message store 82 by wireless router 54 as described in more detail below, with regard to FIG. 9. A mailbox server 52 may also use the acknowledgement to decrement its counter of outstanding messages between itself and the wireless router, described in more detail with regard to FIG. 10.

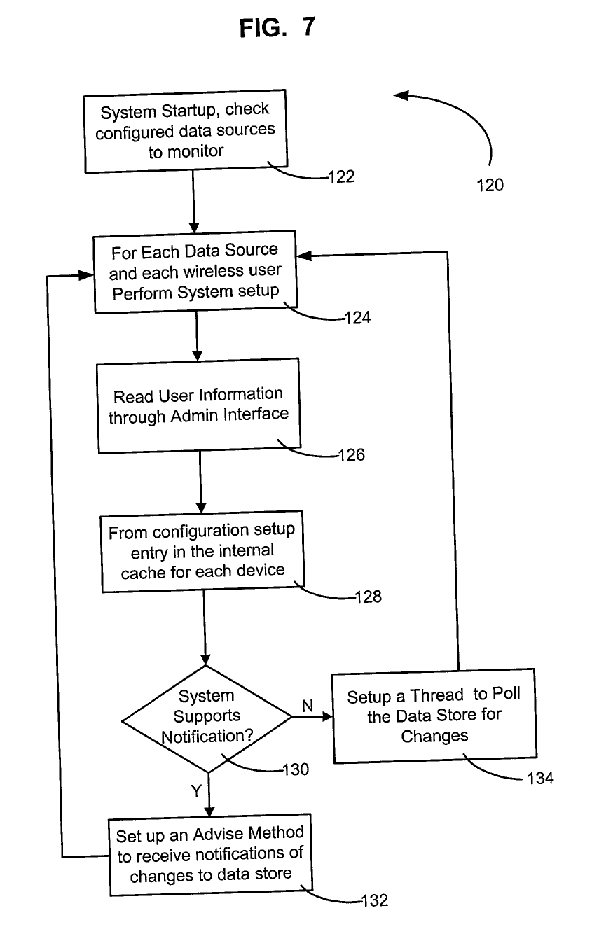

Referring now to FIG. 7, a logical flow diagram of a process for the startup of the system of FIG. 5 is shown generally as 120. FIG. 7 is an expansion of step 92 of process 90 (see FIG. 6). Process 120 begins at step 122 where user information database 86 is consulted to determine which data sources to monitor for changes. At step 124 each data source is examined and associated with the appropriate wireless users. At step 126 the user preferences associated with a particular wireless device are read from the user information database 86. Such preferences would include the types of data that the user does not wish to receive, e.g. no FAXes. At step 128 an internal cache is provided for each wireless device 20. The internal cache is used to pace information to the wireless router and to allow for quick determination on when to process changes to the data store. At step 130, if a data store supports notification, i.e. it will inform the system of any changes to the data store, then control moves to step 132, where a method is set up to receive notification of any data store changes and control returns to step 112. If the data store does not have the capability of informing the system of any changes, a thread is initialized to poll the data store for changes at step 134 and control returns to step 112. Steps 124 through 134 are repeated until all data sources have been associated with the appropriate users.

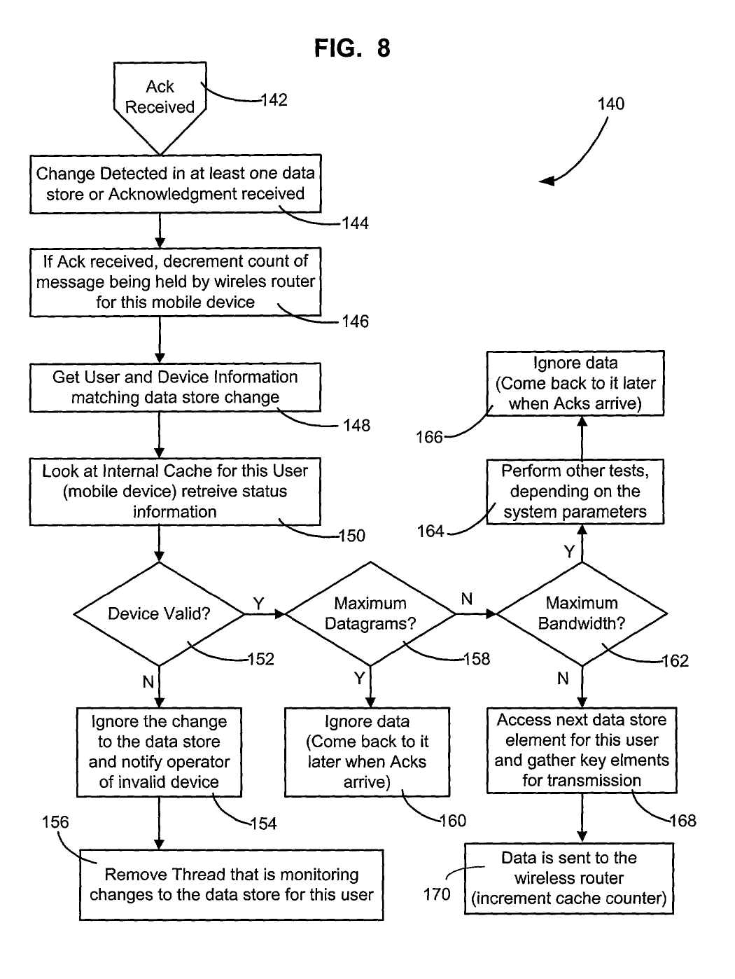

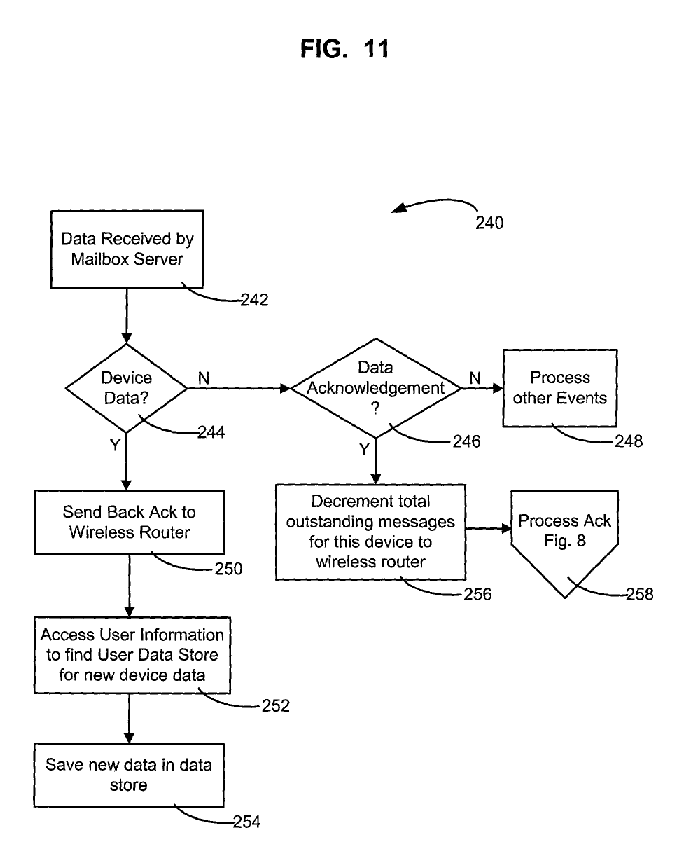

Referring now to FIG. 8, a logical flow diagram of a data store change process is shown generally as 140. FIG. 8 is an expansion of step 94 of process 90 (see FIG. 6) and includes step 96, which is linked to step 94. Process 140 begins at step 144 where a change is detected in a data store such as a user mailbox. Step 144 may also receive an acknowledgement as shown in step 142 which is generated by step 258 of FIG. 11, where an acknowledgment that data has been received by a wireless device has occurred.

The reception of an acknowledgement from FIG. 11 for a given device can trigger the process or determining if any other messages can be sent down to the wireless router on behalf of this same mobile device user. If an acknowledgment has been received, at step 146 the count of outstanding messages, held by the internal cache, for the wireless device sending the acknowledgement is decremented. If a data store change or acknowledgement has been detected, processing moves to step 148 and the information on the user and wireless device to be notified of the data store change is obtained from user information database 86. At step 150 the internal cache is read for the mobile device to determine how many outstanding datagrams have been sent to the wireless router. At step 152 a test is made to determine if the wireless device is fully initialized and valid. This might confirm that the device has not been deactivated by the network administrator.

If it is not considered valid, processing moves to step 154, where the change is ignored and the system administrator (operator of the system) is informed of an invalid device. At step 156, the thread that was monitoring the data store for changes for the user having an invalid device is removed and process 140 terminates.

If at step 152 the device is found to be valid, a test is made at step 158 to determine if the maximum number of outstanding datagrams has been reached. This count limits the number of datagrams sent from the mailbox server to the wireless router for a specific device. This value is kept in the cache and incremented each time another message is sent down to the wireless router. If the maximum number of outstanding datagrams has been reached, processing moves to step 160, where the data is ignored until a device acknowledgment is received. If the maximum number of outstanding datagrams has not been reached, processing moves to step 162. At step 162, a test is made to determine if the datagram sizes plus the wireless network speed has reached a maximum. If the size of the messages being sent are large and the wireless network speed is slow enough, then the throughput and bandwidth might require that less than the total maximum number of datagrams be sent. This type of test would typically be performed on very mature and well-behaved systems that are being careful not to saturate their wireless networks. Typically, a WAN 14 might run at T1 speeds, whereas a wireless network 16 may run at 9600 to 38K baud, so some caution is needed in determining the total data sent.

If the test at step 162 indicates that a maximum has been reached, processing moves to step 164, where further tests may be conducted. In an advanced system, additional tests could be used to bypass the maximum limits for priority data or for SOS or APB (All Points Bulletin) type data. Processing then moves to step 166 and the data is not sent until the network can handle the load. If the test at step 162 indicates the data can be sent, then processing moves to step 168 to access the data to be sent. At step 168, the next data to be sent is processed by the mailbox server. The next data might be the data element that caused the notification, or it could be a previous data item whose processing was deferred until system resources allowed. Once the data is accessed, which might involve stripping attachments, FAX data, and binary data, it is passed to the sending process 170, which sends the message to the router server 76. The sending of the message also causes the internal cache to be incremented to increase the outstanding messages sent to the wireless router and not yet received by the wireless device.

Referring now to FIG. 9, a logical flow diagram of the process of wireless router 54 receiving data from a mailbox server 52 is shown generally as 180. Process 180 expands upon the steps 98, 100, 102, and 104 of process 90 shown in FIG. 6.

Wireless router 54 receives information from both router server 76 and from acknowledgements of previously sent data (see step 224 of FIG. 10). At step 184, a test is made to determine if the message received by wireless router 54 is an acknowledgement or a message from a mailbox server 52. If the message is an acknowledgement, processing moves to step 186. Step 186 purges the data corresponding to the sent message from message store 82 and updates the counters for messages sent and acknowledged.

If the message is from a mailbox server 52, processing moves to step 186 (this is the same as step 98 of process 90) where the message is saved in message store 82. At step 188, an acknowledgement is returned to the mailbox server that sent the message. This acknowledgement allows the mailbox server to mark the message so it doesn't get retransmitted to the wireless device if a failure were to occur.

At step 190 wireless router 54 accesses device/mailbox lookup table 84 to obtain device-to-mailbox mapping information. This information allows router 54 to determine which wireless device 20 the message should be sent to and also assists in building the wireless-ready message required by wireless network 16. Wireless router 54 has a limit on the amount of data that can be sent to wireless network 16. Router 54 is programmed to pace information to a wireless device 20 and pipeline datagrams when it can.

At step 192, the current maximum data transmission for the wireless device receiving the current message is checked to see if a maximum has been reached. If the maximum has been reached, delivery of the data is postponed at until an acknowledgement is received at step 196. If the maximum has not been reached, then the message is delivered at step 198.

Referring now to FIG. 10, this illustrates the logical flow diagram for messages coming in from the wireless network and its optional gateway services component, shown generally as 210. Many of the steps of process 210 are performed by components of FIG. 5. Process 210 begins at step 212 when data is received by wireless router 54 from a wireless device 20. A test is made at step 214 to determine if the data is a message as opposed to a data acknowledgement or other type of data. If it is a message, processing moves to step 220, where the message is stored in message store 82. Processing then moves to step 226, where device/mailbox lookup table 84 is read to determine which mailbox server 52 is managing information for the mobile user that sent the data. The data is then sent by the router server 76 to the appropriate mailbox server 52 at step 230. Once the mailbox server 52 acknowledges receipt of the data, the data will be removed from message store 82 at step 234 and process 210 ends.

Returning to the test of step 214, if the data is not a message then a test is made at step 216 to determine if it is a data acknowledgement. If it is a data acknowledgement, processing moves to step 222 where the message being acknowledged is deleted from message store 82. Also at step 222, the counters for number of messages outstanding for the specific wireless device and the amount of messages to be sent are decremented. At step 224 the flow also goes to FIG. 9 to determine if additional messages are pending for the mobile device that sent the acknowledgement. Processing then moves to step 228 where device/mailbox lookup table 84 is read to determine which mailbox server 52 is managing information for the mobile device that sent the acknowledgement. The acknowledgement is then sent by the router server 76 to the appropriate mailbox server 52 at step 232.

Returning to step 216, if the data was not an acknowledgement, processing moves to step 218 where processing is conducted for data that may be an event other than a message or a data acknowledgement. Such data may include instructions from wireless device 20 to update the status of the wireless device, for example to permit it to receive voice mail messages. There could also be directives from the gateway services component to turn flow control on or off, or other advanced features depending on the wireless network's capabilities.

Referring now to FIG. 11, a logical flow diagram of the process of a mailbox server receiving data is shown generally as 240. At step 242, data is received from the wireless router component 54. At step 244, a test is made to see if the data received is device data. If so, an acknowledgement is passed back to the wireless router at step 250, so that it can be purged from the wireless router's local store. This storage, even for a short period, helps ensure that no data loss occurs if a failure in one of the components should take place. At step 252, the user information is access via the administrator to determine which mailbox is associated to this wireless user. Finally, the new data is saved in the appropriate data store at step 254, and in the case of email, it might result in an email being sent out on behalf of the wireless user.

Returning to step 244, if the message was not device data, then a further check is made at step 246 to determine if it was an acknowledgement. If it was an acknowledgement, then the outstanding count of messages from the mailbox server to the wireless router on behalf of this user is decremented in the internal cache at step 256. This might allow other messages to be passed down to the wireless router. This checking process at step 258 as shown in FIGS. 8 and described above to determine if additional messages are pending.

Returning to step 246, if the message is not an acknowledgement then additional checks may be preformed 248 to look for other events. These checks might include commands from the device user to change monitoring procedures, or even to add or delete preferences.

It is not the intent of the inventors for the present invention to be dependent on a specific email/mailbox server combination. For example, the present invention may work with MAPI or Lotus Notes.

Although the invention has been described with reference to certain specific embodiments, various modifications thereof will be apparent to those skilled in the art without departing from the spirit and scope of the invention as outlined in the claims appended hereto.

We claim:

1. A messaging system for a wireless communication network, the system comprising:
a) a plurality of mailboxes;
b) one or more email servers, each email server connected to a unique subset of the plurality of mailboxes;
c) one or more mailbox servers, each mailbox server connected to a unique subset of the email servers; and
d) a wireless router connected to each of the mailbox servers, the wireless router communicating with the wireless network to transmit messages from the plurality of mailboxes to the wireless network and to transmit messages received from the wireless network to the plurality of mailboxes.

2. The system of claim 1, wherein the wireless router resides between an internal firewall located between the mailbox server and the wireless router and the and an external firewall located between the wireless router and the wireless network.

3. The system of claim 1, wherein the wireless router communicates with the wireless network through a single portal in an external firewall.

4. The system of claim 1, further comprising a server administration component, the server administration component actively connected to the mailbox servers and the router, the administrative component providing services for the addition of new mailbox servers.

5. The system of claim 4, wherein the system further comprises a user information database connected to the server administration component, the user information database containing administration and configuration information.

6. The system of claim 5, wherein the system further comprises a device/mailbox lookup table, the device/mailbox lookup table connected to the wireless router and containing a subset of the information in the user information database.

7. The system of claim 6, wherein the system further comprises a message store, the message store connected to the wireless router and containing a copy of each message transmitted to the wireless network by the wireless router.

8. The system of claim 7, wherein the wireless router, the device/mailbox lookup table and the message store reside in a demilitarized zone (DMZ), the DMZ bounded by an internal firewall and an external firewall.

9. The system of claim 1, wherein the each mailbox server comprises a plurality of clients, each of the clients providing a communication link with a single email server, the clients being configured so that if the single email server drops the communication link, the remaining clients on the mailbox server will continue to communicate with the remainder of the subset of the email servers.

10. A method for transmitting data in a wireless communication system, comprising the steps of:
a) monitoring to detect a change to one or more data stores;
b) determining if the change requires that a message be sent to a wireless device in the wireless communication system, and if so, creating the message, and if not, returning to step a);
c) saving the message in a message store;
d) determining which wireless device should receive the message; and
e) sending the message to the wireless communication system for delivery to the wireless device.

11. The method of claim 10, wherein at least one of the data stores is an email server.

12. The method of claim 10, wherein step a) utilizes a single processing thread for the monitoring to detect a change to one or more data stores.

13. The method of claim 10, wherein at step b), determining if the change requires that a message be sent to a wireless device includes the steps of calculating the number of datagrams to be sent and the speed of the wireless communication system.

14. The method of claim 13, further comprising the step of examining state information for the wireless device to which the message is to be delivered.

15. A system for transmitting data in a wireless communication system, comprising:
a) means for monitoring to detect a change to one or more data stores;
b) means for determining if the change requires that a message be sent to a wireless device in the wireless communication system, and if so, creating the message;
c) means for saving the message in a message store;
d) means for determining which wireless device should receive the message; and
e) means for sending the message to the wireless communication network for delivery to the wireless device.

16. A method of receiving data in a wireless communication network, the method comprising the steps of:
a) determining if the data is a message for a user of the wireless network, and if so:
i) storing the message in a message store;
ii) consulting a lookup table to identify a server controlling data for the user;
iii) sending the data to the server via a router client; and
iv) deleting the message from the message store upon receipt of an acknowledgement from the server; and
b) determining if the data is an acknowledgement of a message received by a wireless device in the wireless communication network, and if so:
i) deleting the message associated with the acknowledgement from a message store;
ii) decrementing the number of outstanding messages sent to the wireless device;
iii) consulting a lookup table to identify a server controlling data for wireless device that sent the acknowledgement; and
iv) informing the server of the acknowledgement.

17. The method of claim 16 further comprising the step at step b) of:
v) determining if additional messages are pending to be sent to the wireless device and if so, attempting to send the messages.

18. A method of managing a data store in a wireless communication network, comprising the steps of:
a) receiving a message from a router;
b) determining if the message comprises data to be stored for a user of the wireless network, and if so:
i) acknowledging the receipt of the message to the router;
ii) identifying a data store for the user;
iii) storing the data from the message in the data store; and
c) determining if the message is an acknowledgement of a message received by a user of the wireless network, and if so, decrementing the total number of outstanding message for the user.

19. The method of claim 18, wherein step c) further comprises the step of determining if there are any further messages to be sent to the user and if so, sending the further messages if possible.
